(19) United States
(12) Patent Application Publication
(10) Pub. No.: US 2025/0316242 A1
(43) Pub. Date: Oct. 9, 2025

(54) TIMING CONTROLLER AND METHOD OF DRIVING TIMING CONTROLLER

(71) Applicant: LX Semicon Co., Ltd., Daejeon (KR)

(72) Inventor: Pyeong Keun OH, Daejeon (KR)

(73) Assignee: LX Semicon Co., Ltd., Daejeon (KR)

(21) Appl. No.: 19/098,793

(22) Filed: Apr. 2, 2025

(30) Foreign Application Priority Data
Apr. 3, 2024 (KR) 10-2024-0045133

(51) Int. Cl. G09G 3/3275

(52) U.S. Cl. CPC G09G 3/3275; G09G 2300/0452; G09G 2300/0842; G09G 2310/08; G09G 2330/021

(57) ABSTRACT

A timing controller and a method of driving a timing controller are disclosed. A method of driving a timing controller according to an exemplary embodiment includes receiving, by a controller, a first request signal requesting loading of line data from a processor, receiving, by the controller, a first address signal for the line data that is loaded together with the first request signal and a second address signal, and loading, by the controller, first line data corresponding to the first address signal into a first shared memory in response to the first request signal, notifying the processor of a completion of loading of the first line data, and then loading second line data corresponding to the second address signal into a second shared memory.

### CROSS-REFERENCE TO RELATED APPLICATION

This application claims priority to and the benefit of Korean Patent Application No. 10-2024-0045133, filed on Apr. 3, 2024, the disclosure of which is incorporated herein by reference in its entirety.

### BACKGROUND

### 1. Field of the Invention

The present invention relates to a timing controller and a method of driving a timing controller.

### 2. Discussion of Related Art

With the advent of the information age, a display field that visually expresses electrical information signals has been rapidly developing, and various display devices with excellent performance have been developed accordingly.

The display device is composed of a display panel, a panel driver that drives the display panel, a source driver that generates a driving voltage that drives a plurality of data lines, a gate driver that generates a driving voltage driving a plurality of gate lines, and a timing controller that controls the panel driver.

The trend is for the timing controller to be applied to systems in a wider range of product groups as well as the display device. Therefore, satisfying a boot time required by the systems is emerging as a key factor of the timing controller.

### SUMMARY OF THE INVENTION

The present invention is directed to a technology that may prevent a storage memory, which stores data that is transmitted to a processor during a data sharing process between a controller and a processor included in a timing controller, from entering a mode for reducing energy consumption because signals are not received for a certain period of time, thereby preventing performance degradation, such as system boot time delay, and furthermore, shortening a boot time.

The problems of the present invention are not limited to the above-described problems, and other aspects that are not described may be obviously understood by those skilled in the art from the following specification.

According to an aspect of the present invention, there is provided a method of driving a timing controller, which includes: receiving, by a controller, a first request signal requesting loading of line data from a processor; receiving, by the controller, a first address signal for the line data that is loaded together with the first request signal and a second address signal; and loading, by the controller, first line data corresponding to the first address signal into a first shared memory in response to the first request signal, notifying the processor of a completion of loading of the first line data, and then loading second line data corresponding to the second address signal into a second shared memory.

The loading of the first line data may include: extracting, by the controller, the first line data from a storage memory in which a plurality of pieces of area data including a plurality of pieces of line data are stored; loading the extracted first line data into the first shared memory; transmitting a completion signal for notifying the completion of the loading of the first line data to the processor when the loading of the extracted first line data is completed; extracting the second line data from the storage memory when the completion signal is transmitted; and loading the extracted second line data into the second shared memory.

The method may further include: receiving, by the controller, a second request signal requesting loading of next line data from the processor; receiving, by the controller, a second address signal and a third address signal for line data that is loaded together with the second request signal; and notifying, by the controller, the processor of the completion of loading of the second line data corresponding to the second address signal in response to the second request signal and then loading third line data corresponding to the third address signal into the first shared memory.

The method may further include extracting, by the controller, third line data corresponding to the third address signal from the storage memory, and loading, by the controller, the extracted third line data into the first shared memory.

The method may further include: receiving, by the controller, a final address signal requesting loading of last line data in any one piece of area data including a plurality of pieces of line data, a termination signal for terminating loading of the any one piece of area data, and a final request signal; transmitting, by the controller, to the processor, a final completion signal notifying that final line data corresponding to the final address signal is loaded into any one of the first shared memory and the second shared memory in response to the final request signal; and deleting, by the controller, the line data loaded into the first shared memory and the second shared memory in response to the termination signal when the controller transmits the final completion signal.

The method may further include setting, by the controller, a shared memory in which a next line data is to be loaded as the first shared memory when the controller deletes the line data loaded into the first shared memory and the second shared memory.

The controller may be implemented as a micro controller unit (MCU), the processor may be implemented as a micro processor unit (MPU), and the storage memory may be implemented as an embedded multi media card (eMMC).

According to another aspect of the present invention, there is provided a timing controller including: a storage memory that stores a plurality of pieces of area data including a plurality of pieces of line data; a processor that requests loading of the plurality of pieces of line data using a request signal and an address signal, receives and processes the loaded line data, and transmits the processed line data; and a controller that includes a first shared memory and a second shared memory where line data is loaded and transmitted, and loads line data extracted from the storage memory into the first shared memory or the second shared memory in response to the request signal, in which the controller receives a first request signal requesting the loading of the line data, a first address signal for the line data that is loaded, and a second address signal from the processor, extracts first line data corresponding to the first address signal from the storage memory and loads the extracted first line data into the first shared memory, and notifies the processor of a completion of the loading of the first line data and then loads second line data corresponding to the second address signal into the second shared memory.

The controller may transmit a completion signal for notifying the completion of the loading of the first line data to the processor when the loading of the extracted first line data is completed, extract the second line data from the storage memory when the completion signal is transmitted, and load the extracted second line data into the second shared memory.

The controller may receive a second request signal requesting loading of next line data from the processor, a second address signal for line data that is loaded, and a third address signal, and may notify the processor of a completion of loading of the second line data corresponding to the second address signal in response to the second request signal, and then load third line data corresponding to the third address signal into the first shared memory.

According to still another aspect of the present invention, there is provided a display device including: a display panel that displays an image; a panel driver that drives the display panel; and a timing controller that controls the panel driver, in which the timing controller includes: a storage memory that stores a plurality of pieces of area data including a plurality of pieces of line data; a processor that requests loading of the plurality of pieces of line data included in the area data using a request signal and an address signal, receives and processes the loaded line data, and transmits the processed line data; and a controller that includes a first shared memory and a second shared memory where line data is loaded and transmitted, and loads line data extracted from the storage memory into the first shared memory or the second shared memory in response to the request signal, in which the controller receives a first request signal requesting the loading of the line data, a first address signal for the line data that is loaded, and a second address signal from the processor, and transmits, to the processor, a first completion signal notifying that the first line data corresponding to the first address signal is extracted from the storage memory and loaded into the first shared memory, and loads the second line data corresponding to the second address signal into the second shared memory.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram schematically illustrating a display device according to an exemplary embodiment;

FIG. 2 is a block diagram illustrating a timing controller according to an exemplary embodiment;

FIG. 3 is a block diagram illustrating a configuration of the timing controller illustrated in FIG. 2;

FIG. 4 is a sequence diagram for describing an operation of the timing controller;

FIGS. 5 to 17 are diagrams for describing signals transmitted and received to and from the timing controller, data, and a processing operation over time;

FIG. 18 is a diagram for describing an example of a case of an improvement effect on a boot time when the timing controller of the present invention is applied; and

FIG. 19 is a diagram for describing an example of a case of an improvement effect on a power-off time when the timing controller of the present invention is applied.

### DETAILED DESCRIPTION OF EXEMPLARY EMBODIMENTS

Hereinafter, exemplary embodiments disclosed in this specification will be described in detail with reference to the accompanying drawings, but the same or similar components will be denoted by the same reference numerals independent of the drawing numerals, and an overlapping description of the same or similar components will be omitted. The terms “module” and “unit” for components used in the following description are used only to easily make the disclosure. Therefore, these terms do not have meanings or roles that are distinguished from each other in themselves. Further, in describing the exemplary embodiments disclosed in this specification, when it is determined that a detailed description of related known technologies may obscure the gist of the exemplary embodiments disclosed in this specification, the detailed description thereof is omitted. In addition, it is to be understood that the accompanying drawings are provided only for easy understanding of exemplary embodiments disclosed in this specification, and the technical idea disclosed in this specification is not limited by the accompanying drawings, but includes all the modifications, equivalents, and substitutions included in the spirit and the scope of the present invention.

Terms including ordinal numbers such as first and second may be used to describe various components, but these components are not limited by these terms. The terms are used to distinguish one component from another component.

It is to be understood that when one component is referred to as being “connected to” or “coupled to” another component, one component may be connected directly to or coupled directly to another component or be connected to or coupled to another component with a still another component interposed therebetween. On the other hand, it is to be understood that when one component is referred to as being “connected directly to” or “coupled directly to” another component, it may be connected to or coupled to another component without other components interposed therebetween.

Singular forms include plural forms unless the context clearly indicates otherwise.

It should be further understood that terms “include” and “have” used in the present specification specify the presence of features, numerals, steps, operations, components, parts described in this specification, or combinations thereof, but do not preclude the presence or addition of one or more other features, numerals, steps, operations, components, parts, or combinations thereof.

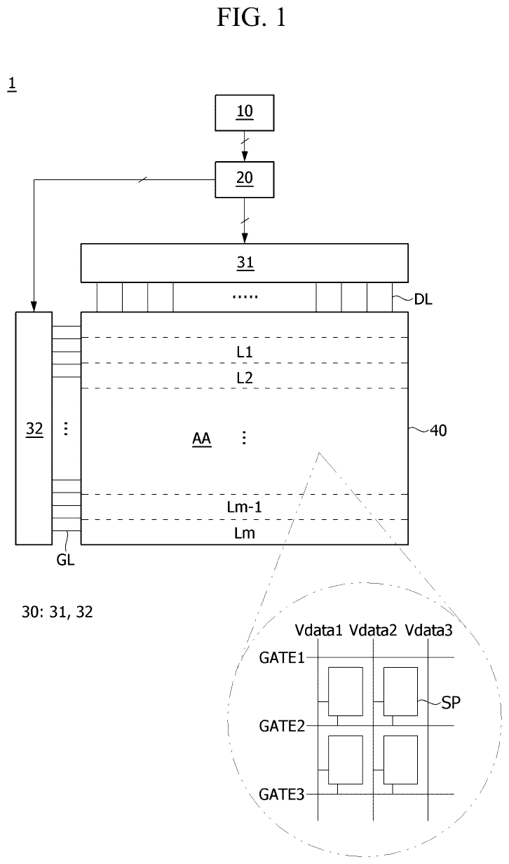

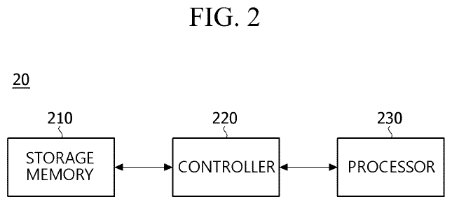

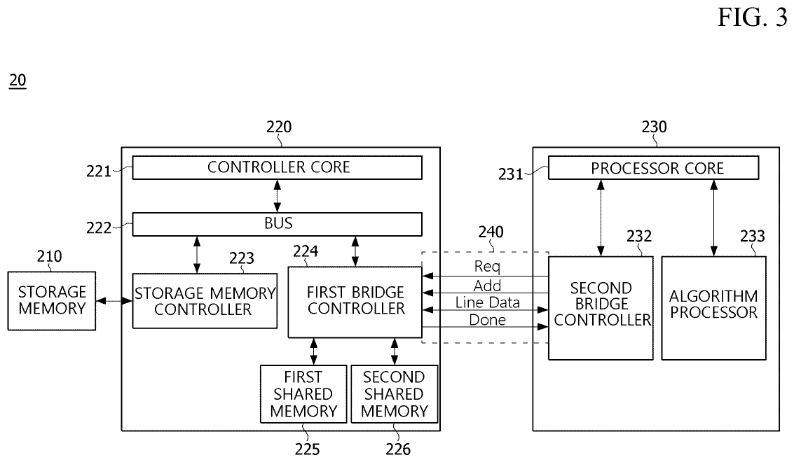

FIG. 1 is a block diagram schematically illustrating a display device, FIG. 2 is a block diagram illustrating a timing controller according to an exemplary embodiment, and FIG. 3 is a block diagram illustrating a configuration of the timing controller illustrated in FIG. 2.

The display device 1 includes a host system 10, a timing controller 20, a panel driver 30, and a display panel 40.

The host system 10 may be one of a television (TV), a set-top box, a navigation system, a personal computer (PC), a home theater, a mobile system, and a wearable system. In mobile devices and wearable devices, the panel driver 30, the timing controller 20, etc., may be integrated into one drive IC (not illustrated).

For example, in a mobile system, the host system 10 may be implemented as an application processor (AP). The host system 10 may transmit pixel data of an input image to a drive IC through a mobile industry processor interface (MIPI). The host system 10 may be connected to the drive IC through, for example, a flexible printed circuit (FPC).

The timing controller 20 may prevent a storage memory 210, which stores data that is transmitted to a processor during a data sharing process between a controller 220 and a processor 230 included in the timing controller 20, from entering a mode for reducing energy consumption because signals are not received for a certain period of time, thereby preventing performance degradation such as a boot time delay of the system including the display device 1 or the timing controller 20, and furthermore, shortening the boot time. That is, the timing controller 20 may be applied not only to the display device 1 but also to other systems (not illustrated).

The timing controller 20 may preload the next line data into a shared memory different from a shared memory in which the current line data is loaded while the current line data is processed, thereby shortening a load time for the next line data.

Even when the processing time of the current line data in the processor is long, by preventing the storage memory, which stores the data that is transmitted to the processor 230 from entering the mode for reducing energy consumption because the signals are not received for a certain period of time, the performance degradation such as the boot time delay of the system including the display device 1 or the timing controller 20 can be prevented and the boot time can further be shortened.

The timing controller 20 may include the storage memory 210, the controller 220, and the processor 230. The timing controller 20 may further include a bridge interface 240.

The storage memory 210 may store a plurality of pieces of area data including a plurality of pieces of line data. The plurality of pieces of area data and the plurality of pieces of line data will be described with reference to FIG. 8.

For example, the storage memory 210 may be implemented as an embedded multi media card (eMMC).

The controller 220 may include a controller core 221, a bus 222, a storage memory controller 223, a first bridge controller 224, a first shared memory 225, and a second shared memory 226.

The controller core 221 may perform operations inside the controller 220, and control peripheral components (not illustrated) inside the timing controller 20.

The bus 222 may connect the controller core 221, the storage memory controller 223, and the first bridge controller 224 so that data and signals may be transmitted.

The storage memory controller 223 may control the storage memory 210, extract data stored in the storage memory 210, and store data in the storage memory 210.

The first bridge controller 224 may perform an operation according to the signal received from the processor 230.

The first bridge controller 224 may load the line data extracted from the storage memory 210 through the storage memory controller 223 into the first shared memory 225 or the second shared memory 226.

After loading the extracted line data, the first bridge controller 224 may transmit a completion signal to the processor 230.

The first bridge controller 224 may transmit the line data loaded into the first shared memory 225 or the second shared memory 226 to the processor 230.

The first bridge controller 224 may store the processed line data received from the processor 230 in the first shared memory 225 or the second shared memory 226.

The line data extracted from the storage memory 210 may be loaded into and/or transmitted to the first shared memory 225.

The line data processed by the processor 230 may be loaded into and/or transmitted to the first shared memory 225.

The line data extracted from the storage memory 210 may be loaded into and/or transmitted to the second shared memory 226.

The line data processed by the processor 230 may be loaded into and/or transmitted to the second shared memory 226.

The controller 220 may receive a first request signal requesting the loading of the line data, a first address signal for the line data that is loaded, and a second address signal from the processor 230.

The controller 220 may transmit, to the processor 230, a first completion signal notifying that the first line data corresponding to the first address signal is extracted from the storage memory 210 and loaded into the first shared memory 225, and may load the second line data corresponding to the second address signal into the second shared memory 226.

For example, the controller 220 may extract the first line data from the storage memory 210. For example, extracting may refer to reading.

The controller 220 may load the extracted first line data into the first shared memory 225.

When the controller 220 completes the loading of the extracted first line data, the controller 220 may transmit the first completion signal to the processor 230.

When the controller 220 transmits the first completion signal, the controller 220 may extract the second line data corresponding to the second address signal from the storage memory 210.

The controller 220 may load the extracted second line data into the second shared memory 226.

The controller 220 may receive a second request signal requesting loading of the next line data, a second address signal for the line data that is loaded, and a third address signal from the processor 230.

The controller 220 may transmit, to the processor 230, a second completion signal notifying that the second line data is loaded into the second shared memory 226 in response to the second address signal received together with the second request signal.

That is, the controller 220 loads the second line data into the second shared memory 226 according to the second address signal received together with the first request signal, omits the line data extraction and loading process according to the second address signal received together with the second request signal, and immediately transmits the second completion signal, and thus the time for loading the second line data into the second shared memory 226 can be shortened.

When the controller 220 transmits the second completion signal, the controller 220 may extract third line data corresponding to the third address signal from the storage memory 210.

The controller 220 may load the extracted third line data into the first shared memory 225.

That is, the controller 220 may repeatedly perform an operation of alternately loading the current (n, n+1, n+2, . . . ) line data and the next (n+1, n+2, n+3, . . . ) line data into the shared memory 225 or 226 according to the current (n, n+1, n+2, . . . ) request signal, the current (n, n+1, n+2, . . . ) address signal, and the next (n+1, n+2, n+3, . . . ) address signal that are received from the processor 230, and an operation of transmitting the corresponding completion signal to the processor 230.

The controller 220 receives the current (n) request signal, the current (n) address signal, and the next (n+1) address signal transmitted by the processor 230 together, and operates the storage memory 210 to preload the next (n+1) line data into the other of the shared memories 225 and 226 in which the current (n) line data is not loaded, thereby preventing the storage memory 210 from entering a mode for reducing energy consumption (e.g., sleep mode, power saving mode, etc.) because a signal is not received for a certain period of time to prevent performance degradation such as a boot time delay for a system including the display device 1 or the timing controller 20, and furthermore, shortening the boot time.

In addition, the controller 220 may immediately transmit the next (n+1) line data loaded into the shared memory 225 or 226 to the processor 230 in response to the next (n+1) address signal received together with the next (n+1) request signal, thereby reducing the time required for the controller 220 to extract the line data from the storage memory 210 to improve the performance of the timing controller 20 such as shortening the boot time.

The controller 220 may receive a final address signal requesting loading of last line data in one piece of area data including a plurality of pieces of line data, a termination signal for terminating the loading of one piece of area data, and a final request signal.

The controller 220 may transmit, to the processor 230, a final completion signal notifying that the final line data corresponding to the final address signal is loaded into one of the first shared memory 225 and the second shared memory 226 in response to the final request signal.

When the controller 220 transmits the final completion signal, the controller 220 may delete the line data loaded into the first shared memory 225 and the second shared memory 226 in response to the termination signal.

When the controller 220 deletes the line data loaded into the first shared memory 225 and the second shared memory 226, the controller 220 may set the shared memory in which the next line data is to be loaded to the first shared memory 225.

The controller 220 may be implemented as a micro controller unit (MCU).

The processor 230 may include a processor core 231, a second bridge controller 232, and an algorithm processor 233.

The processor core 231 may control the second bridge controller 232 and the algorithm processor 233.

The second bridge controller 232 may control the bridge interface 240 according to the request signal transmitted from the processor core 231.

The algorithm processor 233 may process and transmit line data. For example, the algorithm processor 233 may process an algorithm regarding compensation data of an organic light-emitting diode (OLED) panel.

The processor 230 may transmit a first request signal requesting the loading of the line data, a first address signal for line data that is loaded, and a second address signal to the controller 220.

The processor 230 may receive the first line data from the first shared memory 225 of the controller 220 in response to the first completion signal notifying that the controller 220 loads the first line data corresponding to the first address signal into the first shared memory 225.

The processor 230 may process the received first line data and transmit the processed first line data to the controller 220.

The processor 230 may transmit the second request signal requesting the loading of the next line data, the second address signal for the line data that is loaded, and the third address signal to the controller 220.

The processor 230 may receive the second line data from the second shared memory 226 of the controller 220 in response to the second completion signal notifying that the controller 220 loads the second line data corresponding to the second address signal into the second shared memory 226.

The processor 230 may process the received second line data and transmit the processed second line data to the controller 220.

That is, the processor 230 may repeat an operation of transmitting the current (n, n+1, n+2, . . . ) request signal, the current (n, n+1, n+2, . . . ) address signal, and the next (n+1, n+2, n+3, . . . ) address signal to the controller 220, and an operation of receiving the current (n, n+1, n+2, . . . ) line data in response to the completion signal according to the current (n, n+1, n+2, . . . ) address signal, processing the received current (n, n+1, n+2, . . . ) line data, and transmitting the processed current (n, n+1, n+2, . . . ) line data.

The processor 230 may transmit the final address signal requesting the loading of the last line data in one piece of area data including a plurality of pieces of line data, the termination signal for terminating the loading of the area data, and the final request signal to the controller 220.

The processor 230 may receive, from the controller 220, the final completion signal notifying that the final line data corresponding to the final address signal is loaded into one of the first shared memory 225 and the second shared memory 226.

The processor 230 may receive the final line data loaded into one of the first shared memory 225 and the second shared memory 226 in response to the final completion signal.

The processor 230 may process the final line data and transmit the processed final line data to the controller 220.

The processor 230 may transmit a request signal requesting line data of area data different from previously received area data, a current (m, m+1, m+2, . . . ) address signal regarding line data of other area data, and a next (m+1, m+2, m+3, . . . ) address signal to the controller 220 to repeat the above-described operations.

The processor 230 may be implemented as a micro processor unit (MPU).

The timing controller 20 may receive pixel data of an input image and a driving signal synchronized with the pixel data from the host system 10. The timing controller 20 may control the panel driver 30.

The pixel data of the input image received by the timing controller 20 is a digital signal. The timing controller 20 transmits the pixel data to a source driver 31. The timing signal may include a vertical synchronization signal Vsync, a horizontal synchronization signal Hsync, a clock signal DCLK, a data enable signal DE, etc. Since a vertical period and a horizontal period may be known by counting the data enable signal DE, the vertical synchronization signal Vsync and the horizontal synchronization signal Hsync may be omitted. The data enable signal DE has a cycle of one horizontal period 1H.

The timing controller 20 generates a data timing control signal for controlling the source driver 31 and a gate timing control signal for controlling a gate driver 32 based on the timing signal received from the host system 10, thereby controlling the operation timing of the source driver 31 and the gate driver 32.

A voltage level of the gate timing control signal output from the timing controller 20 may be converted into a gate-on voltage VGL and a gate-off voltage VGH through a level shifter (not illustrated) and supplied to the gate driver 32. The level shifter converts a low-level voltage of a gate timing control signal into a gate low voltage VGL and converts a high-level voltage of the gate timing control signal into a gate high voltage VGH.

The bridge interface 240 may transmit signals, data, etc., between the controller 220 and the processor 230.

The panel driver 30 may drive the display panel 40.

The panel driver 30 may include the source driver 31 and the gate driver 32.

The source driver 31 may output output signals corresponding to the image data to the display panel 40 through a data line DL in response to the image data and the horizontal synchronization signal Hsync output from the timing controller 20.

The source driver 31 converts pixel data of an input image received as a digital signal from the timing controller 20 for each frame into an analog gamma compensation voltage using a DAC and outputs data signals Vdata1 to Vdata3. The data signals Vdata1 to Vdata3 may be supplied to the data lines DL.

The gate driver 32 receives a gate timing control signal and outputs gate signals GATE1 to GATE3 synchronized with the data signals Vdata1 to Vdata3 to be supplied to pixel lines GL. The gate signals GATE1 to GATE3 applied to the pixel lines GL turn on switch elements of sub-pixels SP to select the pixel lines on which the voltage of the data signals Vdata1 to Vdata3 is charged.

The display panel 40 may display an image.

The display panel 40 may include a pixel array AA that displays the pixel data of the input image on a screen.

The pixel array AA includes a plurality of data lines DL, a plurality of pixel lines GL intersecting the data lines DL, and pixels arranged in a matrix form. In addition to the matrix form, the arrangement of the pixels may be formed in various ways, such as a form in which pixels that emit the same color are shared, a stripe form, and a diamond form.

When a resolution of a pixel array AA is n*m, the pixel array AA includes n pixel columns and m pixel lines L1 to Lm intersecting the pixel columns. The pixel column includes pixels arranged in a y-axis direction. The pixel line includes pixels arranged in an x-axis direction.

The one horizontal period 1H is a time obtained by dividing the one frame period by the number of m pixel lines L1 to Lm. Pixel data may be written on pixels of 1 pixel line in the one horizontal period 1H. For example, 1 pixel line may be a line to which data voltage is simultaneously input in the one horizontal period 1H.

Each of the pixels may be divided into a red sub-pixel Red, a green sub-pixel Green, and a blue sub-pixel Blue for color implementation. Each of the pixels may further include a white sub-pixel.

Each of the sub-pixels SP includes a pixel circuit. The pixel circuit includes a pixel electrode, a plurality of thin film transistors (TFTs), and a capacitor. The pixel circuit may be connected to the data line DL and the pixel line GL.

The pixel circuit may include a light-emitting element, a plurality of transistors, and a capacitor. The light-emitting element may be implemented as an OLED. Each of the sub-pixels is connected to a pair of data lines and feedback lines and a gate line. The gate line may be divided into a scan line to which a scan signal is applied, and an EM line to which an emission control signal is applied.

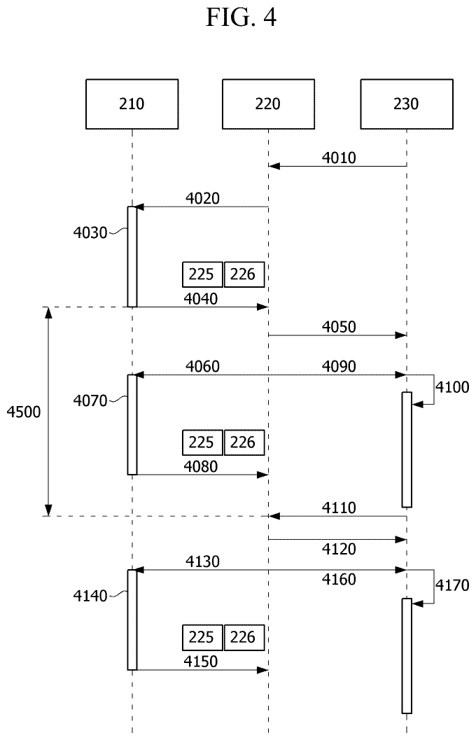

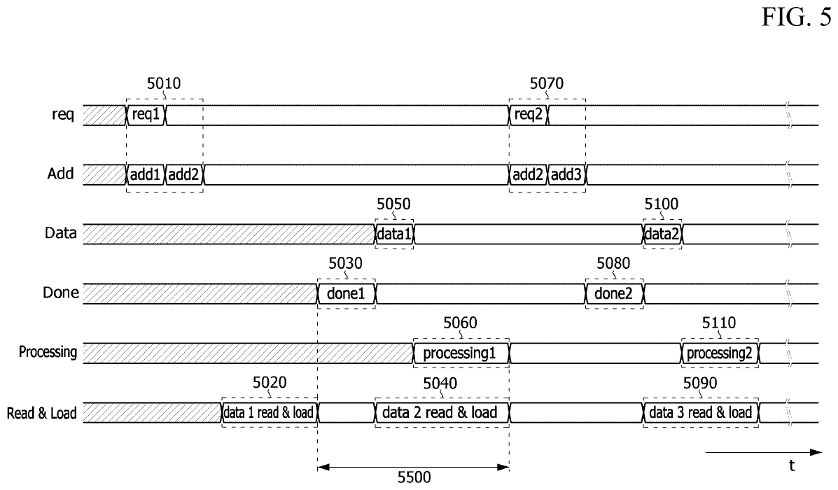

FIG. 4 is a sequence diagram for describing the operation of the timing controller, and FIGS. 5 to 17 are diagrams for describing signals transmitted and received to and from the timing controller, data, and a processing operation over time.

The processor 230 may transmit a first request signal req 1 requesting loading of line data, a first address signal add 1 for line data that is loaded, and a second address signal add 2 to the controller 220 (4010 and 5010).

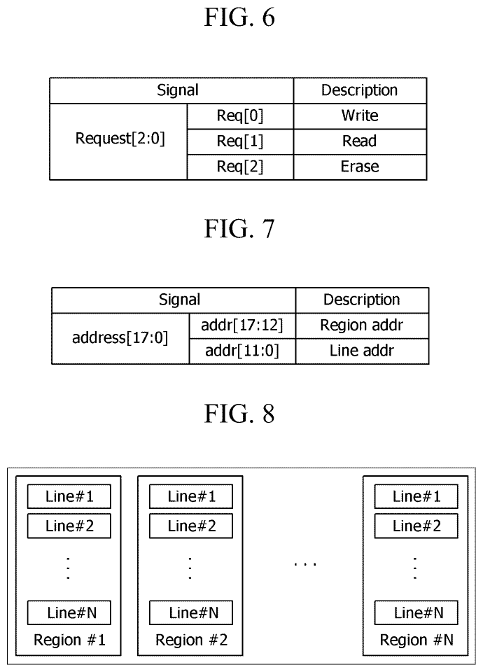

For example, FIG. 6 is an example of a structure for a request signal transmitted by the processor 230, and the request signal may be composed of 3 bits, and bits may be composed of bits for write, read, and erase.

For example, FIG. 7 is an example of an address signal transmitted by a processor 230, and the address signal may be composed of 18 bits, and bits may be composed of bits for an area address for area data and a line address for line data.

For example, FIG. 8 is an example of area data, and a plurality of pieces of area data Region #1 to Region #N may each include a plurality of pieces of line data

Line #1 to Line #N. The area data may be data used in an OLED compensation algorithm.

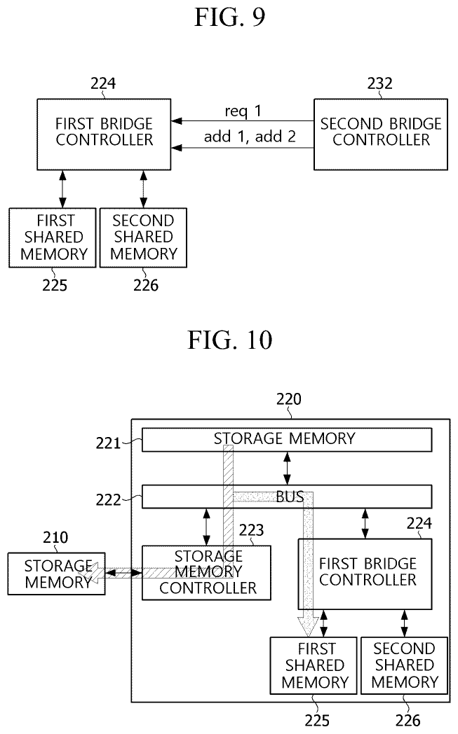

Referring to FIG. 9, the second bridge controller 232 may transmit the first request signal req 1, the first address signal add 1, and the second address signal add 2 to the first bridge controller 224.

The controller 220 may extract the first line data from the storage memory 210 (4020) and load the extracted first line data into the first shared memory 225 (4030 and 5020).

For example, extracting may refer to an operation of the controller 220 that reads the first line data from the storage memory 210.

For example, referring to FIG. 10, the controller core 221 may command the storage memory controller 223 to extract the first line data from the storage memory 210 through the bus 222, and the storage memory controller 223 may extract the first line data from the storage memory 210 and transmit the first line data to the first bridge controller 224 through the bus 222. The first bridge controller 224 may load the first line data into the first shared memory 225.

The storage memory 210 may transmit a first extraction completion signal to the controller 220 when all of the first line data is extracted (4040).

When the controller 220 completes the loading of the extracted first line data, the controller 220 may transmit the first completion signal done 1 to the processor 230 (4050, 5030).

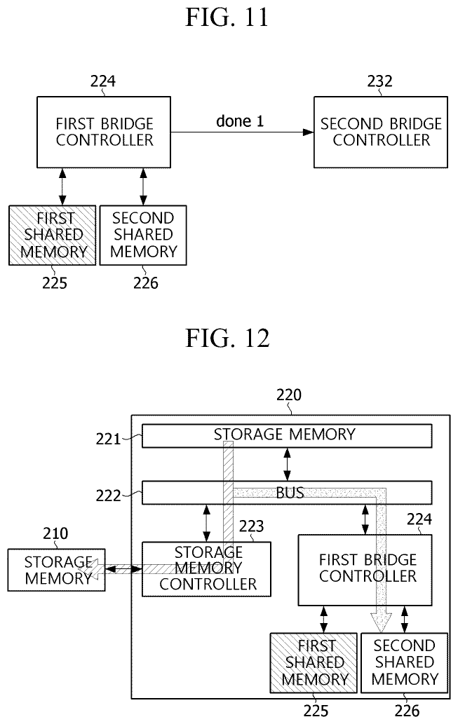

For example, referring to FIG. 11, when the first bridge controller 224 loads all of the extracted first line data into the first shared memory 225, the first bridge controller 224 may transmit the first completion signal done 1 to the second bridge controller 232.

When the controller 220 transmits the first completion signal done 1, the controller 220 may extract the second line data corresponding to the second address signal add 2 from the storage memory 210 (4060) and load the extracted second line data into the second shared memory 226 (4070 and 5040).

For example, referring to FIG. 12, the controller core 221 may command the storage memory controller 223 to extract the second line data from the storage memory 210 through the bus 222, and the storage memory controller 223 may extract the second line data from the storage memory 210 and transmit the second line data to the first bridge controller 224 through the bus 222. The first bridge controller 224 may load the second line data into the second shared memory 226.

The storage memory 210 may transmit a second extraction completion signal to the controller 220 when all of the second line data is extracted (4080).

The processor 230 may receive the first line data data 1 from the first shared memory 225 of the controller 220 in response to the first completion signal done 1 notifying that the controller 220 loads the first line data corresponding to the first address signal add 1 into the first shared memory 225 (4090 and 5050).

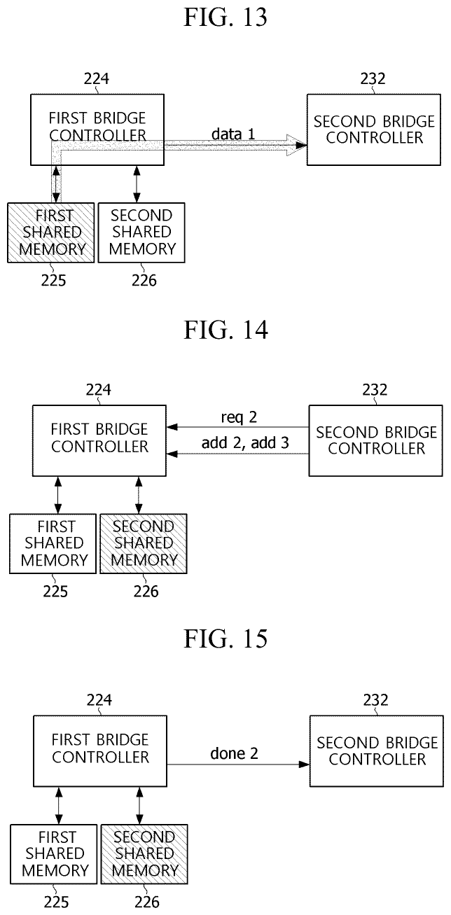

For example, referring to FIG. 13, the second bridge controller 232 may receive the first line data data 1 from the first shared memory 225 through the first bridge controller 224 in response to the first completion signal done 1.

The processor 230 may process the received first line data data 1 (processing 1) and transmit the processed first line data to the controller 220 (4100 and 5060).

Here, when the storage memory 210 does not receive a signal for a certain period of time (4500 and 5500), the storage memory 210 may enter the mode for reducing energy consumption (e.g., sleep mode, power saving mode, etc.). In this case, the processor 230 does not transmit the second request signal req 2 and the second address signal add 2, which are the next signals, to the controller 220 while processing the first line data. However, when the processor 230 transmits the second address signal add 2 together with the first request signal req 1, and the controller 220 may preload the second line data data 2 corresponding to the second address signal add 2 into the second shared memory 226 while the processor 230 processes the first line data data 1, thereby preventing the storage memory 210 from entering the mode for reducing energy consumption (e.g., sleep mode, power saving mode, etc.). In addition, the controller 220 may transmit the second completion signal to the processor 230 directly without the extraction and loading process of the second line data in response to the second address signal add 2 included in the second request signal req 2, thereby reducing the time for operation to improve the performance of the timing controller 20 such as shortening the boot time.

The processor 230 may transmit the second request signal req 2 including the second address signal add 2 and a third address signal add 3 to the controller 220 (4110 and 5070).

For example, referring to FIG. 14, the second bridge controller 232 may transmit the second request signal req 2, the second address signal add 2, and the third address signal add 3 to the first bridge controller 224.

The controller 220 may transmit, to the processor 230, a second completion signal done 2 notifying that the second line data is loaded into the second shared memory 226 in response to the second address signal add 2 received together with the second request signal req 2 (4120 and 5080).

For example, referring to FIG. 15, the first bridge controller 224 may transmit the second completion signal done 2 to the second bridge controller 232 in response to the second address signal add 2 received together with the second request signal req 2.

That is, since the controller 220 previously loads the second line data into the second shared memory 226 using the second address signal add 2 received together with the first request signal req 1 in step 4070, the controller 220 may immediately respond to the second address signal add 2 received together with the second request signal req 2 and transmit the second completion signal done 2 to the processor 230.

When the controller 220 transmits the second completion signal, the controller 220 may extract the third line data corresponding to the third address signal from the storage memory 210 (4130) and load the extracted third line data into the first shared memory 225 (4140 and 5090).

The storage memory 210 may transmit a third extraction completion signal to the controller 220 when all of the third line data is extracted (4150).

The processor 230 may receive the second line data data 2 from the second shared memory 226 of the controller 220 in response to the second completion signal done 2 notifying that the controller 220 loads the second line data corresponding to the second address signal add 2 into the second shared memory 226 (4160 and 5100).

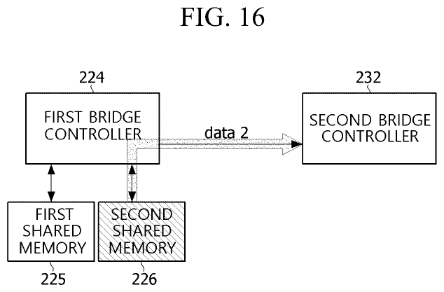

For example, referring to FIG. 16, the second bridge controller 232 may receive the second line data data 2 from the first shared memory 225 through the first bridge controller 224 in response to the second completion signal done 2.

The processor 230 may process the received second line data data 2 (processing 2) and transmit the processed second line data to the controller 220 (4170 and 5110).

As described above, the controller 220 may repeatedly perform an operation of alternately loading the current (n, n+1, n+2, . . . ) line data and the next (n+1, n+2, n+3, . . . ) line data into the shared memory 225 or 226 according to the current (n, n+1, n+2, . . . ) request signal, the current (n, n+1, n+2, . . . ) address signal, and the next (n+1, n+2, n+3, . . . ) address signal that are received from the processor 230, and an operation of transmitting the corresponding completion signal to the processor 230.

As described above, the processor 230 may repeat an operation of transmitting the current (n, n+1, n+2, . . . ) request signal, the current (n, n+1, n+2, . . . ) address signal, and the next (n+1, n+2, n+3, . . . ) address signal to the controller 220, and an operation of receiving the current (n, n+1, n+2, . . . ) line data in response to the completion signal according to the current (n, n+1, n+2, . . . ) address signal, processing the received current (n, n+1, n+2, . . . ) line data, and transmitting the processed current (n, n+1, n+2, . . . ) line data.

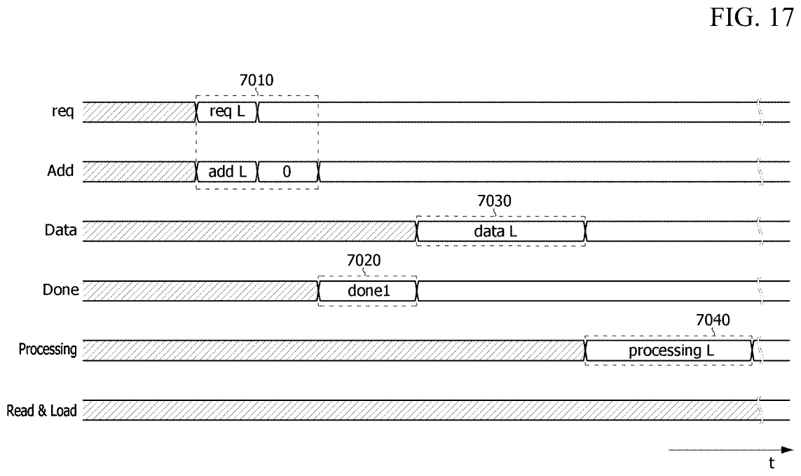

Referring to FIG. 17, the processor 230 may transmit a final address signal add L requesting the loading of the last line data in one piece of area data including a plurality of pieces of line data, a termination signal 0 for terminating the loading of the area data, and a final request signal req L to the controller 220.

The controller 220 may transmit, to the processor 230, a final completion signal done L notifying that the final line data corresponding to the final address signal add L is loaded into one of the first shared memory 225 and the second shared memory 226 in response to the final request signal req L.

For example, the controller 220 may receive the final address signal add L together with a request signal prior to the final request signal req L, and may load the final line data corresponding to the final address signal add L into one of the first shared memory 225 and the second shared memory 226.

When the controller 220 transmits the final completion signal done L, the controller 220 may delete the line data loaded into the first shared memory 225 and the second shared memory 226 in response to the termination signal.

When the controller 220 deletes the line data loaded into the first shared memory 225 and the second shared memory 226, the controller 220 may set the shared memory in which the next line data is to be loaded to the first shared memory 225.

The processor 230 may receive, from the controller 220, the final completion signal done L notifying that the final line data corresponding to the final address signal add L is loaded in one of the first shared memory 225 and the second shared memory 226.

The processor 230 may receive the final line data data L loaded into one of the first shared memory 225 and the second shared memory 226 in response to the final completion signal done L.

The processor 230 may process the final line data data L and transmit the processed final line data to the controller 220.

The processor 230 may transmit a request signal requesting line data of area data different from previously received area data, a current (m, m+1, m+2, . . . ) address signal regarding line data of other area data, and a next (m+1, m+2, m+3, . . . ) address signal to the controller 220 to repeat the above-described operations.

For example, the controller 220 may be implemented as an MCU that is responsible for control of a flash memory, a DDR memory, an inter integrated circuit (I2C), and an input/output interface of the timing controller included in the OLED, and the processor 230 may be implemented as an MPU that processes an image processing algorithm of an OLED panel.

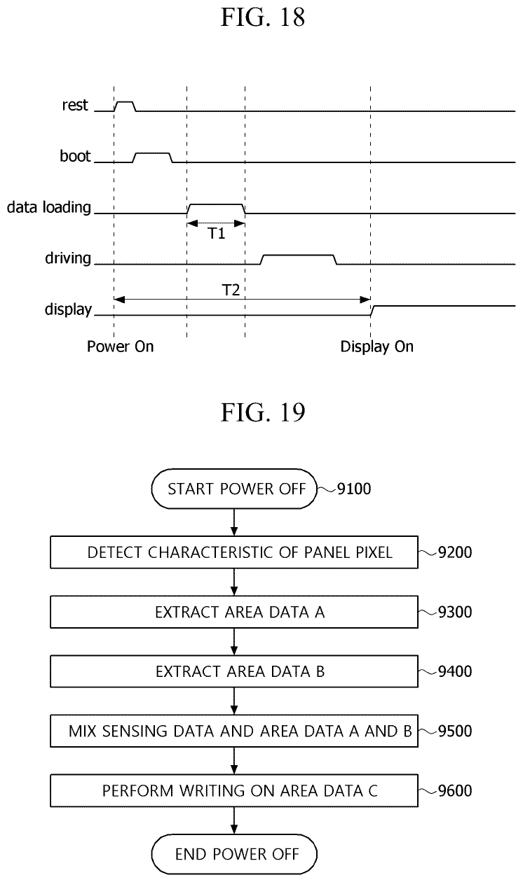

FIG. 18 is a diagram for describing an example of a case of an improvement effect on a boot time when the timing controller of the present invention is applied.

The display device may go through a process of reset, boot, data loading, and driving after power on, and a data loading time T1 used for algorithm compensation in the timing controller may be a factor affecting a display time T2 of the panel after power-on of the display device.

That is, when the data loading time T1 is delayed, the time T2 until the display on is also delayed, which may not satisfy product specifications including the corresponding timing controller, and since the shortening of the display time T2 is a factor affecting the product usage experience, a time reduction for the display time T2 is required.

Accordingly, the operation during the data loading time T1 may be improved through the timing controller 20 of the present invention, so the effect of reducing the display time T2 may be obtained.

Specifically, the processor 230 transmits a next (n+1, n+2, n+3, . . . ) address signal together with the current (n, n+1, n+2, . . . ) address signal to the controller 220, and the controller 220 completes an operation for the current (n, n+1, n+2, . . . ) line data according to the current (n, n+1, n+2, . . . ) address signal, and then pre-loads the next (n+1, n+2, n+3, . . . ) line data according to the next (n+1, n+2, n+3, . . . ) address signal into a shared memory different from the shared memory in which the current (n, n+1, n+2, . . . ) line data is loaded, thereby reducing the data loading time T1, and furthermore, preventing the storage memory 210 from entering the mode for reducing energy consumption (e.g., sleep mode, power saving mode, etc.) to prevent the performance degradation such as the boot time delay.

FIG. 19 is a diagram for describing an example of a case of an improvement effect on a power-off time when the timing controller of the present invention is applied, and specifically, is a diagram illustrating an example of a power-off sequence for a display device.

When a signal for powering off the display device is input, pixel characteristics Vth of panel pixel data before powering off may be detected (9200), area data A and area data B may be extracted (9300, 9400), and the detected pixel characteristic data and area data A and area data B may be mixed (9500) and written on area data C (9600).

In this case, by applying the present invention in operations 9300 and 9400 of extracting the area data A and the area data B, the power-off time can be shortened by reducing the area data extraction time for the power-off sequence for the display device.

That is, as described above, when loading the line data included in the area data, the next (n+1, n+2, n+3, . . . ) line data is pre-loaded into the shared memory different from the shared memory in which the current (n, n+1, n+2, . . . ) line data is loaded while the processor 230 processes the current (n, n+1, n+2, . . . ) line data, thereby reducing the data loading time and shortening the power-off time.

According to the present invention, by preloading the next line data into the shared memory different from the shared memory in which the current line data is loaded while the current line data is processed, it is possible to shorten the load time for the next line data.

In addition, even when the processing time of the current line data in the processor is long, by preventing the storage memory, which stores the data that is transmitted to the processor during the data sharing process between the controller and the processor included in the timing controller, from entering the mode for reducing energy consumption because the signals are not received for a certain period of time, it is possible to prevent the performance degradation, such as the system boot time delay, and furthermore, shorten the boot time.

The effects of the present invention are not limited to the above-described effects, and other effects that are not described may be obviously understood by one of ordinary skill in the art from the claims.

Although exemplary embodiments of the present invention have been described in more detail with reference to the accompanying drawings, the present invention is not necessarily limited to these exemplary embodiments, but may be variously modified without departing from the scope and spirit of the present invention. Accordingly, exemplary embodiments disclosed in this specification are not intended to limit the spirit of the present disclosure but are to describe the spirit of the present disclosure. The technical idea of the present invention is not limited to these exemplary embodiments. Therefore, it should be understood that the above-described exemplary embodiments are exemplary in all aspects but are not limited thereto. The scope of the present invention should be interpreted by the following claims, and it should be interpreted that all spirits equivalent to the following claims fall within the scope of the present invention.

What is claimed is:

1. A method of driving a timing controller, comprising:
receiving, by a controller, a first request signal requesting loading of line data from a processor;
receiving, by the controller, a first address signal for the line data that is loaded together with the first request signal and a second address signal; and
loading, by the controller, first line data corresponding to the first address signal into a first shared memory in response to the first request signal, notifying the processor of a completion of loading of the first line data, and then loading second line data corresponding to the second address signal into a second shared memory.

2. The method of claim 1, wherein the loading of the first line data includes:
extracting, by the controller, the first line data from a storage memory in which a plurality of pieces of area data including a plurality of pieces of line data are stored;
loading the extracted first line data into the first shared memory;
transmitting a completion signal for notifying the completion of the loading of the first line data to the processor when the loading of the extracted first line data is completed;
extracting the second line data from the storage memory when the completion signal is transmitted; and
loading the extracted second line data into the second shared memory.

3. The method of claim 1, further comprising:
notifying, by the controller, the processor of the completion of the loading of the first line data and then transmitting the first line data loaded into the first shared memory to the processor; and
processing, by the processor, the first line data received from the controller, and then transmitting a second request signal requesting loading of a next line data, a second address signal for the line data that is loaded, and a third address signal to the controller.

4. The method of claim 3, wherein, in the transmitting to the controller, the processor processes the first line data received from the controller and transmits the processed first line data to the controller, and then transmits the second request signal, the second address signal, and the third address signal to the controller.

5. The method of claim 3, further comprising:
receiving, by the controller, the second request signal, the second address signal, and the third address signal from the processor; and
notifying, by the controller, the processor of the completion of the loading of the second line data corresponding to the second address signal in response to the second request signal and then loading third line data corresponding to the third address signal into the first shared memory.

6. The method of claim 5, wherein the loading of the third line data into the first shared memory includes:
extracting, by the controller, the third line data corresponding to the third address signal from the storage memory; and
loading the extracted third line data into the first shared memory.

7. The method of claim 5, further comprising notifying, by the controller, the processor of the completion of the loading of the second line data and then transmitting the second line data loaded into the second shared memory to the processor.

8. The method of claim 1, further comprising:
receiving, by the controller, a final address signal requesting loading of last line data in any one piece of area data including a plurality of pieces of line data, a termination signal for terminating loading of the any one piece of area data, and a final request signal;
transmitting, by the controller, to the processor, a final completion signal notifying that final line data corresponding to the final address signal is loaded into any one of the first shared memory and the second shared memory in response to the final request signal; and
deleting, by the controller, the line data loaded into the first shared memory and the second shared memory in response to the termination signal when the controller transmits the final completion signal.

9. The method of claim 8, further comprising setting, by the controller, a shared memory in which a next line data is to be loaded as the first shared memory when the controller deletes the line data loaded into the first shared memory and the second shared memory.

10. The method of claim 1, wherein the controller is implemented as a micro controller unit (MCU), the processor is implemented as a micro processor unit (MPU), and the storage memory is implemented as an embedded multi media card (eMMC).

11. A timing controller comprising:
a storage memory that stores a plurality of pieces of area data including a plurality of pieces of line data;
a processor that requests loading of the plurality of pieces of line data using a request signal and an address signal, receives and processes the loaded line data, and transmits the processed line data; and
a controller that includes a first shared memory and a second shared memory where line data is loaded and transmitted, and loads line data extracted from the storage memory into the first shared memory or the second shared memory in response to the request signal,
wherein the controller receives a first request signal requesting the loading of the line data, a first address signal for the line data that is loaded, and a second address signal from the processor, extracts first line data corresponding to the first address signal from the storage memory and loads the extracted first line data into the first shared memory, and notifies the processor of a completion of the loading of the first line data and then loads second line data corresponding to the second address signal into the second shared memory.

12. The timing controller of claim 11, wherein the controller transmits a completion signal for notifying the completion of the loading of the first line data to the processor when the loading of the extracted first line data is completed,
extracts the second line data from the storage memory when the completion signal is transmitted, and
loads the extracted second line data into the second shared memory.

13. The timing controller of claim 11, wherein the controller notifies the processor of the completion of the loading of the first line data and then transmits the first line data loaded into the first shared memory to the processor, and
the processor processes the first line data received from the controller and then transmits a second request signal requesting loading of a next line data, a second address signal for the line data that is loaded, and a third address signal to the controller.

14. The timing controller of claim 13, wherein the processor processes the first line data received from the controller and transmits the processed first line data to the controller, and then transmits the second request signal, the second address signal, and the third address signal to the controller.

15. The timing controller of claim 13, wherein the controller receives the second request signal, the second address signal, and the third address signal from the processor, and
notifies the processor of the completion of the loading of the second line data corresponding to the second address signal in response to the second request signal and then loads third line data corresponding to the third address signal into the first shared memory.

16. The timing controller of claim 15, wherein the controller extracts the third line data corresponding to the third address signal from the storage memory, and
loads the extracted third line data into the first shared memory.

17. The timing controller of claim 15, wherein the controller notifies the processor of the completion of the loading of the second line data and then transmits the second line data loaded into the second shared memory to the processor.

18. The timing controller of claim 11, wherein the controller receives a final address signal requesting loading of last line data in any one piece of area data including a plurality of pieces of line data, a termination signal for terminating loading of the any one piece of area data, and a final request signal,
transmits, to the processor, a final completion signal notifying that final line data corresponding to the final address signal is loaded into any one of the first shared memory and the second shared memory in response to the final request signal, and
deletes the line data loaded into the first shared memory and the second shared memory in response to the termination signal when transmitting the final completion signal.

19. The timing controller of claim 18, wherein the controller sets a shared memory in which a next line data is to be loaded as the first shared memory when the controller deletes the line data loaded into the first shared memory and the second shared memory.

20. The timing controller of claim 11, wherein the controller is implemented as a micro controller unit (MCU), the processor is implemented as a micro processor unit (MPU), and the storage memory is implemented as an embedded multi media card (eMMC).
